(19) United States
(12) Patent Application Publication
(10) Pub. No.: US 2011/0135897 A1
(43) Pub. Date: Jun. 9, 2011

(54) Coated Article and Method for Making a Coated Article

(75) Inventor: Albir Layyous, Me'ilya (IL)

(73) Assignee: Iscar, Ltd., Tefen (IL)

(21) Appl. No.: 12/952,905

(22) Filed: Nov. 23, 2010

(30) Foreign Application Priority Data
Dec. 6, 2009 (IL) 202549

(51) Int. Cl. B32B 7/02; B32B 15/04; B05D 7/24; C23C 16/08; B82Y 30/00

(52) U.S. Cl. 428/216; 427/404; 427/249.17; 427/250; 977/840

(57) ABSTRACT

A tool or wear part has a coating formed over a substrate. The coating includes at least one sequence of a ductile nano-layer located between two hard layers, though the coating may have several such sequences created by alternating ductile nano-layers with hard layers, with adjacent sequences sharing a hard layer. The various hard layers may differ in composition from one another, as can the ductile nano-layers. An optional adhesion layer may be provided between the substrate and the sequence, and an optional top layer may be provided over the outermost hard layer. The various layers may be deposited by physical vapor deposition in a single chamber.

### FIELD OF THE INVENTION

The present invention relates to an article such as a cutting tool for metal machining or a wear part at least partially coated with a thick PVD coating having hard layers and ductile nano-layers.

### BACKGROUND OF THE INVENTION

It is known that coatings increase the working life of cutting tools or wear parts. PVD coatings have several attractive properties compared to CVD coatings, for example finer grained coatings and compressive stresses in the as-deposited state. However, PVD coatings are relatively thin, seeing as thicker PVD coatings are prone to spalling, frittering, cutting edge spalling and flaking all of which limit tool life.

Coatings having a metal layer that is deposited directly onto the surface of the substrate are known. This is known to enhance the adhesion of a PVD coating to a substrate.

EP 2072637 A2 describes a coating for a cutting tool which has a metallic interlayer placed between at least two non-metallic, functional layers or layer systems where the metallic interlayer comprises at least 60 at % metal elements chosen from one or more of Ti, Mo, Al, Cr, V, Y, Nb, W, Ta and Zr, or mixtures thereof. The non-metallic, functional layer or layer system is one or more of nitrides, oxides, borides, carbides, or combinations thereof.

### SUMMARY OF THE INVENTION

In accordance with an aspect of the present invention there is provided an at least partially coated article comprising a substrate and a coating. The article may be a cutting tool or may be a wear part. The coating has alternating layers of a ductile nano-layer and a hard layer adhered to each other, there being at least one sequence of three layers comprising a ductile nano-layer located between two hard layers.

The ductile nano-layer is at least 70 at % metal elements. At least 0.5 at % of the ductile nano-layer is chosen from one or more metals of the group consisting of Fe, Co, Ni, Cu, Hf, Ag, Au and Ru. The thickness of the ductile nano-layer is from 5 nm to 100 nm.

The hard layer is one or more ceramic layers that are nitrides, oxides, borides, carbides, or combinations thereof. The thickness of the hard layer is from 0.05 μm to 5 μm. Typically the hard layers are composed of (MeₐX₁₋ₐ)(N_{w}CₓB_{y}O_{z}) wherein Me is one or more metals chosen from the group consisting of Ti, Al, Cr and Zr; and X is one or more of elements chosen from the group consisting of Si, Ta, V, Y, and Nb, wherein 0.75<a≦1.0; and w+x+y+z=1).

In accordance with some embodiments, the ductile nano-layer is a pure metal layer consisting of one or more metals selected from the group consisting of Fe, Co, Ni, Cu, Hf, Ag, Au and Ru.

In some embodiments, the ductile nano-layer is a pure metal layer comprising from 0.5 at % to 99.5 at % of one or more metals selected from the group consisting of Fe, Co, Ni, Cu, Hf, Ag, Au, and Ru, the remainder comprising one or more metals chosen from the group consisting of Al, Y, and refractory metals.

In some embodiments of the invention, the ductile nano-layer is sub-stoichiometric ceramic further comprising a non-metal component selected from the group consisting of N, O, C, B and combinations thereof.

In accordance with some embodiments, the coating comprises between 3 and 30 such sequences created by alternating ductile nano-layers with hard layers.

In some embodiments, the coating has at least two ductile nano-layers having compositions which differ from one another.

In accordance with some embodiments, the coating further comprises one or more auxiliary layers. An auxiliary layer may be adjacent the substrate, in which case it serves as an adhesion layer between the substrate and the first hard layer. Alternatively, or in addition, an auxiliary layer may be adjacent an uppermost hard layer in which case it serves as an outermost top layer of the coating. In all instances, when present, an auxiliary layer comprises at least 60% elements chosen from the group consisting of Hf, Al, Y, Fe, Co, Ni, Cu, Si, Ag, Au, Ru, refractory metals and mixtures thereof, and the thickness of the auxiliary layer is from 2 nm to 100 nm.

Typically, the total coating thickness is from 0.5 μm to 20 μm.

In another aspect of the invention, there is provided a method of making a coated article such as a cutting tool or a wear part comprising a substrate and coating. The method comprising the steps of:

a) depositing at least one hard layer over the substrate, the at least one hard layer comprising nitrides, oxides, borides, carbides, or combinations thereof,

b) depositing one ductile nano-layer on the at least one hard layer, the one ductile nano-layer comprising at least 70 at % metal elements. At least 0.5 at % of the ductile nano-layer is chosen from one or more metals of the group consisting of Fe, Co, Ni, Cu, Hf, Ag, Au and Ru,

c) depositing at least one other hard layer on the ductile nano-layer, the at least one other hard layer comprising nitrides, oxides, borides, carbides, or combinations thereof.

Typically, the thickness of each of the hard layers is from 0.05 μm to 5 μm and the thickness of the ductile nano-layer is from 5 nm to 100 nm.

Typically, the coating is deposited with a PVD technique.

Optionally, the deposited hard layers are composed of (MeₐX₁₋ₐ)(N_{w}CₓB_{y}O_{z}) wherein Me is one of more metals selected from the group consisting of Ti, Al, Cr and Zr; X is one or more elements selected from the group consisting of Si, Ta, V, Y, and Nb; wherein 0.75<a≦1.0; and w+x+y+z=1.

In some embodiments of the invention, steps b) and c) are alternatingly performed between 3 and 30 times.

In accordance with some embodiments, the coating method further comprises: depositing a first auxiliary layer onto the substrate, prior to carrying out step b); and alternatively, or in addition

depositing a second auxiliary layer onto the outermost hard layer, whereby the second auxiliary layer serves as an outermost layer of the coating; wherein:

the first and second auxiliary layers each comprise at least 60% elements chosen from the group consisting of Hf, Al, Y, Fe, Co, Ni, Cu, Si, Ag, Au, Ru, refractory metals and mixtures thereof; and

the thickness of each auxiliary layer is from 2 nm to 100 nm.

### BRIEF DESCRIPTION OF THE DRAWINGS

FIG. 1 shows an exemplary coating in accordance with the present invention.

### DETAILED DESCRIPTION OF THE INVENTION

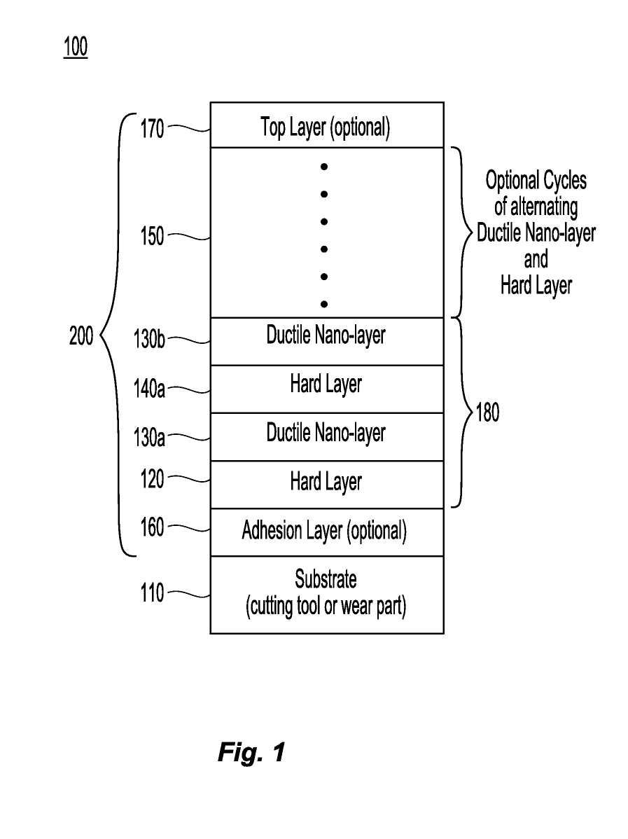

With reference to FIG. 1, the present invention relates to an article 100 including a substrate 110 and a coating, 200 the substrate being at least partially coated with a coating with alternating layers of a ductile nano-layer 130a, 130b and a hard layer 120, 140a adhered to each other. The coating has at least one sequence 180 of three layers: a metallic ductile nano-layer 130a located between two hard layers 120, 140a. The term “sequence” will be used throughout this text with the above meaning. The metallic ductile nano-layer is at least 70 at % of one or more metal elements. The metal elements may be any metal, preferably Al, Fe, Co Ni, Cu, Hf, Ag, Au, Ru, refractory metals or mixtures thereof. At least 0.5 at % of the ductile nano-layer is chosen from one or more metals of the group consisting of Fe, Co, Ni, Cu, Hf, Ag, Au and Ru. The alloying of a metallic nano-layer with Fe Cr, Ni, or Hf improves oxidation resistance. Alloying with Ni improves adhesive properties while alloying with Hf improves heat resistance. Alloying with Cu, Ag and Au increases ductility and wettability of the ductile layer and improves its adhesion to the hard layers.

The thickness of the ductile nano-layer may be from 5 nm to 100 nm, preferably from 10 to 50 nm. The coating has at least one sequence comprising a ductile nano-layer located between two hard layers, and may have additional sequences (shown generally as 150 in FIG. 1) created by alternating ductile nano-layers with hard layers, it being understood that adjacent sequences have a hard layer in common. The coating 200 may have between 3 and 30 such sequences, and more preferably between 5 and 20 sequences.

The term “hard layer” will be used throughout this text to include within its meaning both a single ceramic layer and a ceramic multilayer. A ceramic layer may be a nitride, oxide, boride, carbide, or combinations thereof. A ceramic multilayer is hereinafter to mean at least two ceramic layers which are consecutively deposited without a ductile nano-layer in-between.

The term “refractory metals” will be used throughout the description and claims to be the following metals: titanium, zirconium, vanadium, niobium, tantalum, chromium, molybdenum, tungsten, or mixtures thereof.

The hard layers can have any composition suitable for cutting tools and/or wear parts, such as nitrides, oxides, borides, carbides, or combinations thereof. The hard layers can be the same or different from each other with regard to structure and composition. Optionally, the hard layers may be composed of (MeₐX₁₋ₐ)(N_{w}CₓB_{y}O_{z}) wherein Me is one of more metals chosen from Ti, Al, Cr and Zr and wherein X is one or more elements chosen from Si, Ta, V, Y, and Nb (0.75<a≦1.0 and w+x+y+z=1). By way of example, the hard layers may be any one of (Al,Ti)N, TiN, (Al,Cr)N, CrN, ZrN, Ti(B,N), TiB₂, or (Zr,Al)N.

The hard layers according to the present invention may have any coating structure common in the art of coating cutting tools or wear parts. The hard layers of any sequence of the coating, may be similar or may differ from each other with regard to structure and composition. The hard layers of different sequences may differ from each other with regard to structure and composition.

The average thickness of a hard layer can be 0.05-5 μm, preferably 0.15-2 μm. The hard layers are substantially thicker than the ductile nano-layers. The thickness of the coating can be from 0.6 to 20 μm, preferably from 1 to 15 μm and most preferably from 2 to 9 μm.

The coated article may be a cutting tool or a wear part. The cutting tool may be a one-piece solid cutting tool, a cutting tool consisting of an insert holder and a cutting insert secured therein, an insert holder, or a cutting insert. The wear part may be a component used in applications where wear is a recognized problem. Wear parts may be for various wear applications such as, for example, machine parts, textile machine parts, ball bearings, roller bearings, moving parts in heat exchangers, turbo loaders, gas-turbine, exhaust valves, nozzles, manufacturing process dies for example for extrusion or wire drawing, punches, blanking tools, hot forging and pressing, molds, shear blades, plunger rods for pumps, plunger ball blanks, down hole pump check valve blanks, bushings, and other wear and impact applications.

The substrate of the article may be made of a hard metal, a cermet, high speed steel, oxide, carbide, nitride or boride ceramics, a super abrasive (PcBN or PCD), carbon steel, low alloyed steels, austenitic, ferritic or martensitic stainless steels, hot work tool steels, cold work tool steels, 51000 steels, nickel and cobalt super alloys.

The coating of the invention may optionally have at least one auxiliary layer. The auxiliary layer may be located adjacent the substrate in which case it serves as an adhesion layer 160, or the auxiliary layer may be located adjacent the outermost hard layer in which case it serves as an outermost top layer 170 of the coating 200. In some embodiments, a first auxiliary layer serves as an adhesion layer 160 between the substrate 110 and the first hard layer 120, while a second auxiliary layer serves as an outermost top layer 170 of the coating 200. The auxiliary layer comprises at least 60% elements chosen from Hf, Al, Y, Fe, Co, Ni, Cu, Si, Ag, Au, Ru, refractory metals and mixtures thereof; the thickness of the auxiliary layer is from 2 nm to 100 nm.

In one embodiment of the present invention, the ductile nano-layer is a pure metal nano-layer where the metal is chosen from Fe, Co, Ni, Cu, Hf, Ag, Au, Ru, and mixtures thereof.

In another embodiment of the present invention, the ductile nano-layer is a pure metal nano-layer where at least 0.5 at % of the metal is chosen from Fe, Co, Ni, Cu, Hf, Ag, Au and Ru, and mixtures thereof.

In another embodiment of the present invention, the ductile nano-layer is a pure metal nano-layer comprising at least 0.5 at % of one or more metals chosen from Fe, Co, Ni, Cu, Hf, Ag, Au, Ru, with the remainder comprising one or more metals chosen from Al, Y and refractory metals.

In another embodiment of the present invention, the ductile nano-layer is a sub-stoichiometric ceramic, a non-metal element thereof is one or more of N, O, C, or B and the metal thereof is selected from the group consisting of Fe, Co, Ni, Cu, Hf, Ag, Au, Ru, and mixtures thereof. Optionally the ductile nano-layer is a nitride. The amount of the metal element in the sub-stoichiometric ceramic is at least 70 at %, preferably 80 at %, more preferably at least 90 at % of the sub-stoichiometric ceramic.

In another embodiment of the present invention, the ductile nano-layer is a sub-stoichiometric ceramic, the non-metal element thereof is one or more of N, O, C, or B and where at least 0.5 at % of the metal thereof is selected from the group consisting of Fe, Co, Ni, Cu, Hf, Ag, Au, Ru, and mixtures thereof. Optionally the ductile nano-layer is a nitride. The amount of the metal element(s) in the sub-stoichiometric ceramic is at least 70 at %, preferably 80 at %, more preferably at least 90 at % of the sub-stoichiometric ceramic.

In other embodiments of the present invention the coating has more than one sequence of alternating hard layers and ductile nano-layers selected from one or more of the ductile nano-layers described in the previous embodiments. Optionally the coating has at least two ductile nano-layers having different compositions. For example, the coating may have ductile nano-layers of different pure metal compositions or the coating may have at least one pure metal nano-layer and at least one sub-stoichiometric nano-layer or at least two sub-stoichiometric nano-layers having different compositions.

In another embodiment of the present invention, the at least two hard layers are selected from TiAlN and AlTiN having a thickness of between 0.5 to 2 μm, and the ductile nano-layers are TiₓCu_{y} or TiₓAg_{y} (x+y=1 and x≦0.9) having a thickness preferably between 20 to 50 nm.

In another embodiment of the present invention, the ductile nano-layer is an alloy consisting essentially of Cu, Ti and Al wherein Cu is at least 2 at %.

In yet another embodiment of the present invention, the ductile nano-layer is an alloy consisting essentially of Cu, Al and Cr wherein Cu is at least 2 at %.

The present invention also relates to a method of making the coated article such as the coated cutting tool or the coated wear part described in any of the above embodiments. The method comprises the steps of:

a) depositing at least one hard layer over a substrate,

b) depositing a ductile nano-layer on the at least one hard layer, and

c) depositing at least one other hard layer on the ductile nano-layer.

Steps b) and c), as described above preferably are performed between 3 and 30 times, and more preferably between 5 and 20 times, until the desired total coating thickness is achieved.

The ductile nano-layer is preferably deposited within the same coating chamber, and in same coating sequence, as the hard layers by changing the atmosphere from a reactive gas to an inert gas, e.g. He, Ar, Kr, Xe or a combination of these gases.

In other embodiments of the present invention, the coating method further comprises:

depositing a first auxiliary layer onto the substrate, prior to carrying out step b); and alternatively, or in addition

depositing a second auxiliary top layer onto the outermost hard layer.

The first auxiliary layer serves as an adhesion layer between the substrate and the first hard layer. The second auxiliary layer serves as an outermost top layer of the coating. In all instances, when present, the auxiliary layer is at least 60 at % of one or more elements chosen from the group consisting of Hf, Al, Y, Fe, Co, Ni, Cu, Si, Ag, Au, Ru and refractory metals. The thickness of the auxiliary layer is from 2 nm to 100 nm.

Any PVD technique commonly used when coating cutting tools or wear parts can be used in the method of the present invention. Preferably cathodic arc evaporation or magnetron sputtering is used, although emerging technologies such as HIPIMS (high power impulse magnetron sputtering), could also be used. Even if the coating according to the present invention is referred to as a “PVD-coating” the coating can also be deposited with for example a PECVD technique (Plasma Enhanced Chemical Vapor Deposition) which will generate coatings with properties closer to those of PVD coatings than conventional CVD coatings.

What is claimed is:

1. An at least partially coated article comprising a substrate and a coating;
the coating comprising alternating layers of a ductile nano-layer and a hard layer adhered to each other, there being at least one sequence of three layers comprising a ductile nano-layer located between two hard layers wherein:
the ductile nano-layer comprises at least 70 at % metal elements and at least 0.5 at % of the ductile nano-layer is chosen from one or more metals of the group consisting of Fe, Co, Ni, Cu, Hf, Ag, Au and Ru;
the hard layer comprises one or more ceramic layers that are nitrides, oxides, borides, carbides, or combinations thereof;
the thickness of the hard layer is from 0.05 μm to 5 μm; and
the thickness of the ductile nano-layer is from 5 nm to 100 nm.

2. The coated article according to claim 1 wherein the hard layers are composed of (MeₐX₁₋ₐ)(N_{w}CₓB_{y}O_{z}); wherein:
Me is one or more metals chosen from the group consisting of Ti, Al, Cr and Zr;
X is one or more of elements chosen from the group consisting of Si, Ta, V, Y, and Nb;
0.75<a≦1.0; and
w+x+y+z=1.

3. The coated article according to claim 1, wherein the ductile nano-layer is a pure metal layer consisting of one or more metals selected from the group consisting of Fe, Co, Ni, Cu, Hf, Ag, Au and Ru.

4. The coated article according to claim 1, wherein the ductile nano-layer is a pure metal layer comprising:
from 0.5 at % to 99.5 at % of one or more metals selected from the group consisting of Fe, Co, Ni, Cu, Hf, Ag, Au, and Ru; and
the remainder comprising one or more metals chosen from the group consisting of Al, Y, and refractory metals.

5. The coated article according to claim 1, wherein the ductile nano-layer is a sub-stoichiometric ceramic further comprising a non-metal component selected from the group consisting of N, O, C, B and combinations thereof.

6. The coated article according to claim 1, wherein the coating comprises between 3 and 30 such sequences.

7. The coated article according to claim 6 comprising at least two ductile nano-layers having compositions which differ from one another.

8. The coated article according to claim 1, wherein the coating further comprises:
an auxiliary layer adjacent the substrate and serving as an adhesion layer between the substrate and a hard layer, wherein:
the auxiliary layer comprises at least 60% elements chosen from the group consisting of Hf, Al, Y, Fe, Co, Ni, Cu, Si, Ag, Au, Ru, refractory metals and mixtures thereof; and
the thickness of the auxiliary layer is from 2 nm to 100 nm.

9. The coated article according to claim 1, wherein the coating further comprises:
an auxiliary layer adjacent an outermost hard layer and serving as an outermost top layer of the coating, wherein:
the auxiliary layer comprises at least 60% elements chosen from the group consisting of Hf, Al, Y, Fe, Co, Ni, Cu, Si, Ag, Au, Ru, refractory metals and mixtures thereof; and
the thickness of the auxiliary layer is from 2 nm to 100 nm.

10. The coated article according to claim 1, wherein the coating further comprises:
a first auxiliary layer adjacent the substrate and serving as an adhesion layer between the substrate and a hard layer; and
a second auxiliary layer adjacent an outermost hard layer and serving as an outermost top layer of the coating, wherein:
the first and second auxiliary layers each comprise at least 60% elements chosen from group consisting of Hf, Al, Y, Fe, Co, Ni, Cu, Si, Ag, Au, Ru, refractory metals and mixtures thereof; and
the thickness of each auxiliary layer is from 2 nm to 100 nm.

11. The coated article according to claim 1, wherein the thickness of the coating is from 0.5 μm to 20 μm.

12. The coated article according to claim 1, wherein the article is a cutting tool or a wear part.

13. The coated article according to claim 1, wherein the ductile nano-layer is selected from the group consisting of TiₓCu_{y}, TiₓAg_{y}, TiᵤAlᵥCuₜ; and CrᵤAlᵥCuₜ; wherein x+y=1 and x≦0.9 and u+v+t=1 and t≧0.02.

14. A method of making a coated article comprising a substrate and a coating, the method comprising the steps of:
a) depositing at least one hard layer over the substrate, the at least one hard layer comprising nitrides, oxides, borides, carbides, or combinations thereof;
b) depositing at least one ductile nano-layer on the at least one hard layer, the at least one ductile nano-layer comprising at least 70 at % metal elements and at least 0.5 at % of the ductile nano-layer is chosen from one or more metals of the group consisting of Fe, Co, Ni, Cu, Hf, Ag, Au and Ru; and
c) depositing at least one other hard layer on the ductile nano-layer, the at least one other hard layer comprising nitrides, oxides, borides, carbides, or combinations thereof; wherein:
the thickness of each of the hard layers is from 0.05 μm to 5 μm; and
the thickness of the at least one ductile nano-layer is from 5 nm to 100 nm.

15. The method according to claim 14, wherein the coating is deposited with a PVD technique.

16. The method according to claim 14, wherein the deposited, hard layers are composed of (MeₐX₁₋ₐ)(N_{w}CₓB_{y}O_{z}); wherein:
Me is one or more metals selected from the group consisting of Ti, Al, Cr and Zr;
X is one or more elements selected from the group consisting of Si, Ta, V, Y, and Nb;
0.75<a≦1.0; and
w+x+y+z=1.

17. The method according to claim 14, wherein steps b) and c) are alternatingly performed between 3 and 30 times.

18. The method according to claim 14, further comprising:
depositing an auxiliary layer onto the substrate, prior to carrying out step b); wherein:
the auxiliary layer comprises at least 60% elements chosen from the group consisting of Hf, Al, Y, Fe, Co, Ni, Cu, Si, Ag, Au, Ru, refractory metals and mixtures thereof; and
wherein the thickness of the auxiliary layer is from 2 nm to 100 nm.

19. The method according to claim 14, further comprising:
depositing an auxiliary layer onto an outermost hard layer, whereby the auxiliary layer serves as an outermost layer of the coating, wherein:
the auxiliary layer comprises at least 60% elements chosen from the group consisting of Hf, Al, Y, Fe, Co, Ni, Cu, Si, Ag, Au, Ru, refractory metals and mixtures thereof; and
wherein the thickness of the auxiliary layer is from 2 nm to 100 nm.

20. The method according to claim 14, further comprising:
depositing a first auxiliary layer onto the substrate, prior to carrying out step b); and
depositing a second auxiliary layer onto an outermost hard layer, whereby the second auxiliary layer serves as an outermost layer of the coating, wherein:
the first and second auxiliary layers each comprise at least 60% elements chosen from the group consisting of Hf, Al, Y, Fe, Co, Ni, Cu, Si, Ag, Au, Ru, refractory metals and mixtures thereof; and
the thickness of each auxiliary layer is from 2 nm to 100 nm.

21. The method according to claim 14, wherein:
steps b) and c) are alternatingly performed between 3 and 30 times in the same coating chamber using physical vapor deposition.
